(19) United States
(12) Patent Application Publication
(10) Pub. No.: US 2013/0054295 A1
(43) Pub. Date: Feb. 28, 2013

(54) PROVIDING INDICATIONS BY A CALENDARING SYSTEM THAT A MEETING HAS BEEN PREVIOUSLY RESCHEDULED TO AID IN SCHEDULING

(71) Applicants: Kulvir S. Bhogal, Pflugerville, TX (US); Lisa Seacat DeLuca, San Francisco, CA (US); Robert R. Peterson, Austin, TX (US)

(72) Inventors: Kulvir S. Bhogal, Pflugerville, TX (US); Lisa Seacat DeLuca, San Francisco, CA (US); Robert R. Peterson, Austin, TX (US)

(73) Assignee: INTERNATIONAL BUSINESS MACHINES CORPORATION, Armonk, NY (US)

(21) Appl. No.: 13/220,279

(22) Filed: Aug. 29, 2011

(51) Int. Cl. G06Q 10/00

(52) U.S. Cl. 705/7.19

(57) ABSTRACT

A method, system and computer program product for informing users regarding the rescheduling of a meeting. A counter, associated with a meeting, is set to the value of 1 when the meeting has been rescheduled for the first time. Upon a user (e.g., meeting initiator, meeting recipient) proposing to reschedule the meeting a further time, an indicator is presented to the user informing the user that the meeting has been previously rescheduled. Such information may be used by the user to decide whether to proceed with rescheduling the meeting. If the user decides to proceed, the counter is incremented and a meeting invitation is generated, where the meeting invitation includes an indication (e.g., number of times the meeting has been rescheduled obtained from the counter) regarding the meeting having been previously rescheduled. In this manner, the meeting recipients would have knowledge that the meeting has been previously rescheduled.

### TECHNICAL FIELD

The present invention relates to calendaring systems, and more particularly to a calendaring system that provides indications that a meeting has been previously rescheduled to aid in scheduling.

### BACKGROUND

Calendaring systems maintain a number of scheduled events to help users manage their time. Many calendaring systems are collaborative, which permit a sharing of calendar events, such as meetings, among a set of meeting participants.

In some instances, a meeting may have to be rescheduled due to various circumstances, such as scheduling conflicts. At times, a meeting may have to be rescheduled multiple times. In such circumstances, it may be desirable to know whether a meeting has been rescheduled multiple times for various reasons, such as to ensure that the recipient of the meeting notice gives priority to this meeting over other conflicting meetings. Also, it may be desirable for the meeting scheduler to know if a meeting has been rescheduled multiple times to select a better time and/or date or perhaps elect to not schedule the meeting at all due to a lack of interest.

Currently, calendaring systems do not provide any indications that a meeting has been rescheduled repeatedly which would be advantageous to know for both the meeting scheduler and the meeting recipients.

### BRIEF SUMMARY

In one embodiment of the present invention, a method for informing users regarding the rescheduling of a meeting comprises determining a meeting has been rescheduled. The method further comprises generating, by a processor, an indication to a user regarding the meeting having been previously rescheduled in response to the user proposing to subsequently reschedule the rescheduled meeting.

Other forms of the embodiment of the method described above are in a system and in a computer program product.

The foregoing has outlined rather generally the features and technical advantages of one or more embodiments of the present invention in order that the detailed description of the present invention that follows may be better understood. Additional features and advantages of the present invention will be described hereinafter which may form the subject of the claims of the present invention.

### BRIEF DESCRIPTION OF THE SEVERAL VIEWS OF THE DRAWINGS

A better understanding of the present invention can be obtained when the following detailed description is considered in conjunction with the following drawings, in which:

FIG. 1 illustrates a calendaring system configured in accordance with an embodiment of the present invention;

FIG. 2 illustrates a hardware configuration of a client device configured in accordance with an embodiment of the present invention;

FIG. 3 illustrates a hardware configuration of a server configured in accordance with an embodiment of the present invention;

FIGS. 4A-4B are a flowchart of a method for informing users that a meeting has been previously rescheduled in accordance with an embodiment of the present invention;

FIG. 5 illustrates a calendar user interface that includes indications regarding the likelihood that a rescheduled meeting will be rescheduled a further time in accordance with an embodiment of the present invention; and

FIG. 6 is a flowchart of a method for providing an indication in the calendar user interface of the attendees that indicates that the scheduled meeting had previously been rescheduled in accordance with an embodiment of the present invention.

### DETAILED DESCRIPTION

The present invention comprises a method, system and computer program product for informing users regarding the rescheduling of a meeting. In one embodiment of the present invention, a counter, associated with a meeting, is set to the value of 1 when the meeting has been rescheduled for the first time. The counter is used to store the number of times that the meeting has been rescheduled. Upon a user (e.g., meeting initiator, meeting recipient) proposing to reschedule the meeting a further time, an indicator, such a warning, is presented to the user informing the user that the meeting has already been rescheduled. Such information may be used by the user to decide whether to proceed with rescheduling the meeting. If the user decides to proceed with rescheduling the meeting a subsequent time, the counter is incremented and a meeting invitation is generated, where the meeting invitation includes an indication (e.g., a color change, a count indicating the number of times the meeting has been rescheduled) regarding the meeting having been previously rescheduled. In this manner, the meeting recipients would have knowledge that the meeting has been previously rescheduled. Furthermore, an indication may be provided in the calendar user interface regarding the likelihood that the rescheduled meeting will be rescheduled a further time. Such information may be used by the recipients of the meeting invitation in deciding whether to propose an alternative date and/or time in the case of a scheduling conflict.

In the following description, numerous specific details are set forth to provide a thorough understanding of the present invention. However, it will be apparent to those skilled in the art that the present invention may be practiced without such specific details. In other instances, well-known circuits have been shown in block diagram form in order not to obscure the present invention in unnecessary detail. For the most part, details considering timing considerations and the like have been omitted inasmuch as such details are not necessary to obtain a complete understanding of the present invention and are within the skills of persons of ordinary skill in the relevant art.

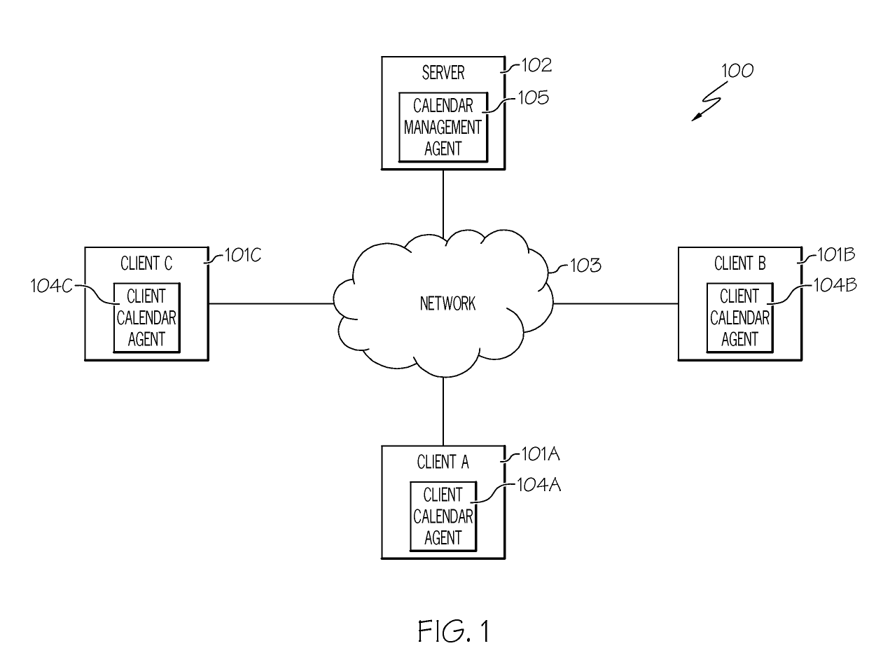

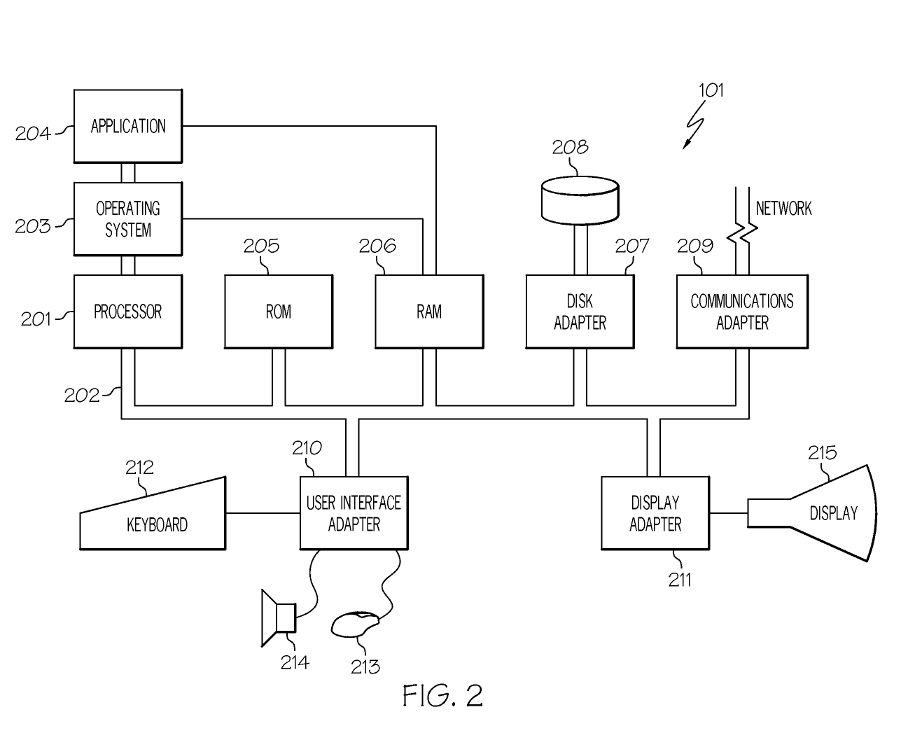

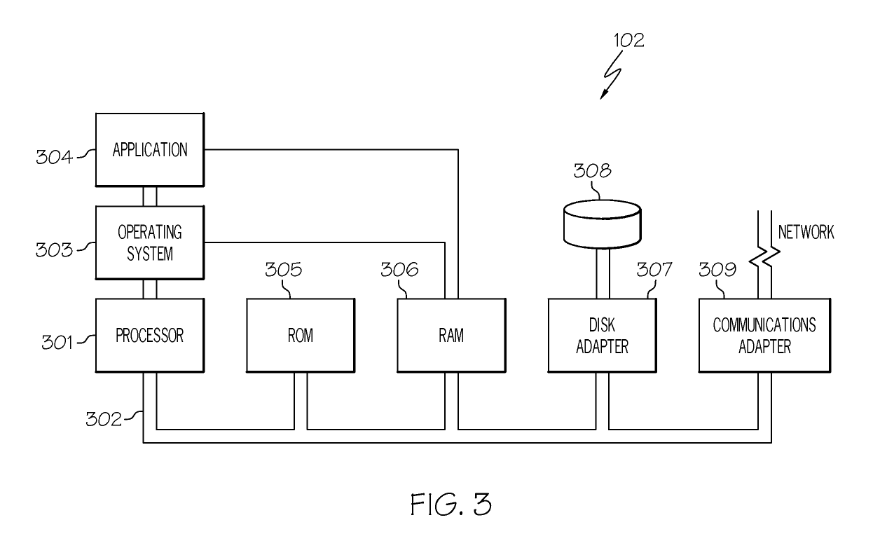

Referring now to the Figures in detail, FIG. 1 illustrates a calendaring system 100 for practicing the principles of the present invention in accordance with an embodiment of the present invention. Calendaring system 100 includes client systems 101A-101C (identified as “Client A,” “Client B,” and “Client C,” respectively, in FIG. 1) connected to a server 102 via a network 103. Clients 101A-101C may collectively or individually be referred to as clients 101 or client 101, respectively. Client 101 may be any type of computing device (e.g., portable computing unit, personal digital assistant (PDA), smartphone, laptop computer, mobile phone, navigation device, game console, desktop computer system, workstation, Internet appliance and the like) configured with the capability of connecting to network 103 and consequently communicating with other clients 101 and server 102. Each client 101 is configured to send out calendar appointments or meeting notices/invitations to other clients 101 using a calendar application (not shown) via network 103. Any user of client 101 may be the creator or initiator of a meeting invitation and any user of client 101 may be a recipient of a meeting invitation. A description of the hardware configuration of client 101 is provided below in connection with FIG. 2. Furthermore, a description of the hardware configuration of server 102 is provided below in connection with FIG. 3.

Network 103 may be, for example, a local area network, a wide area network, a wireless wide area network, a circuit-switched telephone network, a Global System for Mobile Communications (GSM) network, Wireless Application Protocol (WAP) network, a WiFi network, an IEEE 802.11 standards network, various combinations thereof, etc. Other networks, whose descriptions are omitted here for brevity, may also be used in conjunction with system 100 of FIG. 1 without departing from the scope of the present invention.

In calendaring system 100, clients 101A-101C include a software agent, referred to herein as a client calendar agent 104A-104C, respectively. Client calendar agents 104A-104C may collectively or individually be referred to as client calendar agents 104 or client calendar agent 104, respectively. Furthermore, sever 102 includes a software agent, referred to herein as the calendar management agent 105. Calendar management agent 105 interfaces with client calendar agent 104 to present meeting invitations to clients 101, where the meeting invitations may include indications (e.g., color changes) to inform the users (e.g., meeting recipient) that the meeting has previously been rescheduled, as discussed further below. Client calendar agent 104 is configured to display the received meeting invitation as well as display calendar schedule information on the client's 101 calendar user interface.

While FIG. 1 illustrates three clients 101A-101C and a single server 102, calendaring system 100 may include any number of clients 101 and servers 102. The embodiments of calendaring system 100 are not to be limited in scope to the depiction of FIG. 1.

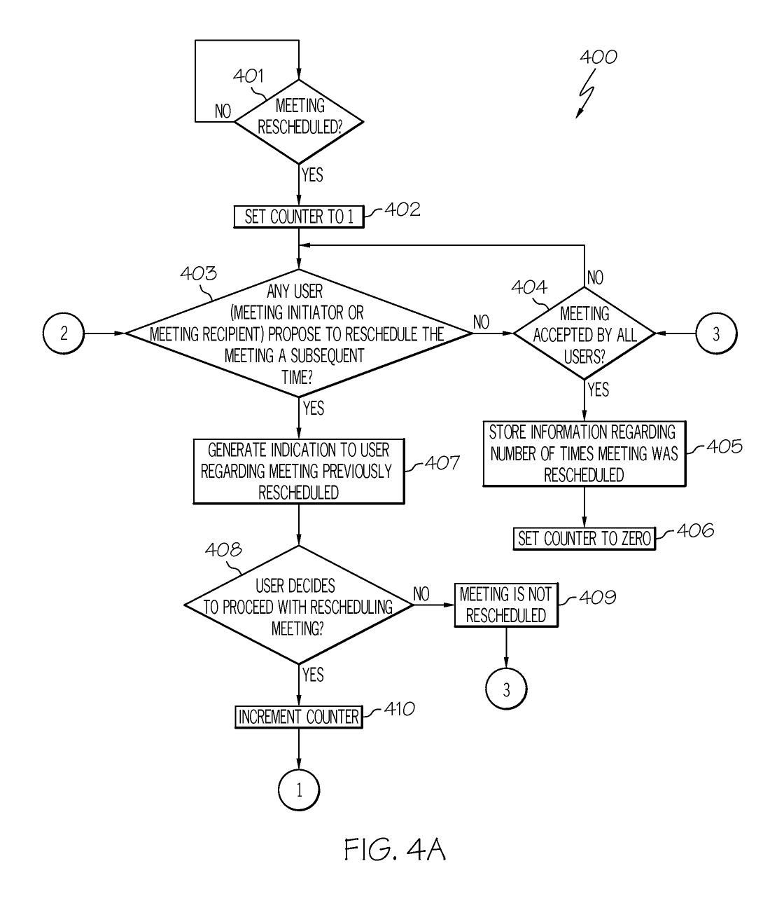

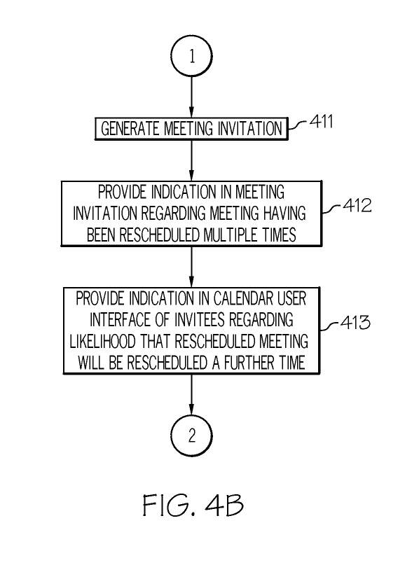

Referring now to FIG. 2, FIG. 2 illustrates a hardware configuration of client 101 (FIG. 1) which is representative of a hardware environment for practicing the present invention. Referring to FIG. 2, client 101 has a processor 201 coupled to various other components by system bus 202. An operating system 203 runs on processor 201 and provides control and coordinates the functions of the various components of FIG. 2. An application 204 in accordance with the principles of the present invention runs in conjunction with operating system 203 and provides calls to operating system 203 where the calls implement the various functions or services to be performed by application 204. Application 204 may include, for example, a calendar application, a client calendar agent 104 (FIG. 1), as discussed further below in association with FIGS. 4A-4B, 5 and 6.

Referring again to FIG. 2, read-only memory (“ROM”) 205 is coupled to system bus 202 and includes a basic input/output system (“BIOS”) that controls certain basic functions of client 101. Random access memory (“RAM”) 206 and disk adapter 207 are also coupled to system bus 202. It should be noted that software components including operating system 203 and application 204 may be loaded into RAM 206, which may be client's 101 main memory for execution. Disk adapter 207 may be an integrated drive electronics (“IDE”) adapter that communicates with a disk unit 208, e.g., disk drive.

Client 101 may further include a communications adapter 209 coupled to bus 202. Communications adapter 209 interconnects bus 202 with an outside network (network 103) thereby enabling client 101 to communicate with other clients 101 and server 102.

I/O devices may also be connected to client 101 via a user interface adapter 210 and a display adapter 211. Keyboard 212, mouse 213 and speaker 214 may all be interconnected to bus 202 through user interface adapter 210. Data may be inputted to client 101 through any of these devices. A display monitor 215 may be connected to system bus 202 by display adapter 211. In this manner, a user is capable of inputting to client 101 through keyboard 212 or mouse 213 and receiving output from client 101 via display 215 or speaker 214.

As stated above, FIG. 3 illustrates a hardware configuration of a server 102 (FIG. 1) which is representative of a hardware environment for practicing the present invention. Referring to FIG. 3, server 102 has a processor 301 coupled to various other components by system bus 302. An operating system 303 runs on processor 301 and provides control and coordinates the functions of the various components of FIG. 3. An application 304 in accordance with the principles of the present invention runs in conjunction with operating system 303 and provides calls to operating system 303 where the calls implement the various functions or services to be performed by application 304. Application 304 may include, for example, a counter, a program for informing users regarding the rescheduling of a meeting, as discussed further below in association with FIGS. 4A-4B, 5 and 6.

Referring again to FIG. 3, read-only memory (“ROM”) 305 is coupled to system bus 302 and includes a basic input/output system (“BIOS”) that controls certain basic functions of server 102. Random access memory (“RAM”) 306 and disk adapter 307 are also coupled to system bus 302. It should be noted that software components including operating system 303 and application 304 may be loaded into RAM 306, which may be server's 102 main memory for execution. Disk adapter 307 may be an integrated drive electronics (“IDE”) adapter that communicates with a disk unit 308, e.g., disk drive. It is noted that the program for informing users regarding the rescheduling of a meeting, as discussed further below in association with FIGS. 4A-4B, 5 and 6, may reside in disk unit 308 or in application 304.

Server 102 may further include a communications adapter 309 coupled to bus 302. Communications adapter 309 interconnects bus 302 with an outside network (network 103) thereby allowing server 102 to communicate with clients 101.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” ‘module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or flash memory), a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the C programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the present invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the function/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the function/acts specified in the flowchart and/or block diagram block or blocks.

As stated in the Background section, in some instances, a meeting may have to be rescheduled due to various circumstances, such as scheduling conflicts. At times, a meeting may have to be rescheduled multiple times. In such circumstances, it may be desirable to know whether a meeting has been rescheduled multiple times for various reasons, such as to ensure that the recipient of the meeting notice gives priority to this meeting over other conflicting meetings. Also, it may be desirable for the meeting scheduler to know if a meeting has been rescheduled multiple times to select a better time and/or date or perhaps elect to not schedule the meeting at all due to a lack of interest. Currently, calendaring systems do not provide any indications that a meeting has been rescheduled repeatedly which would be advantageous to know for both the meeting scheduler and the meeting recipients.

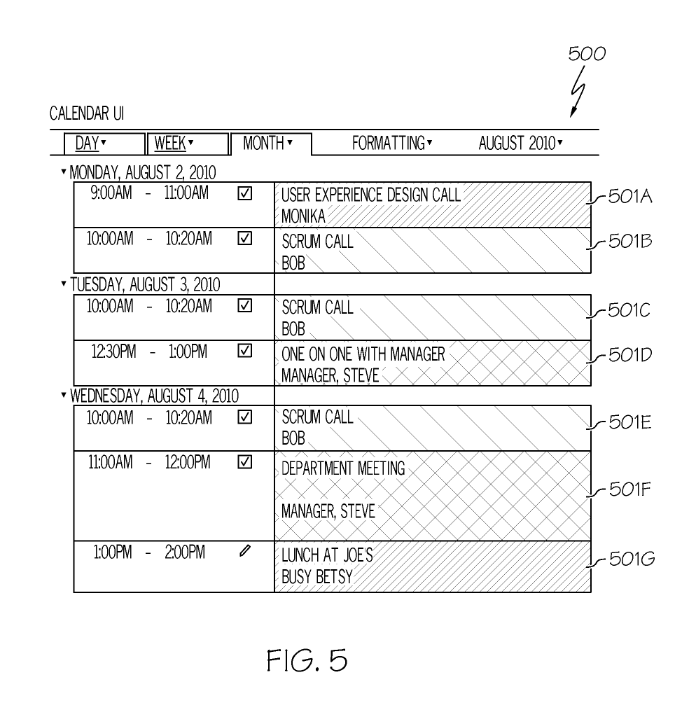

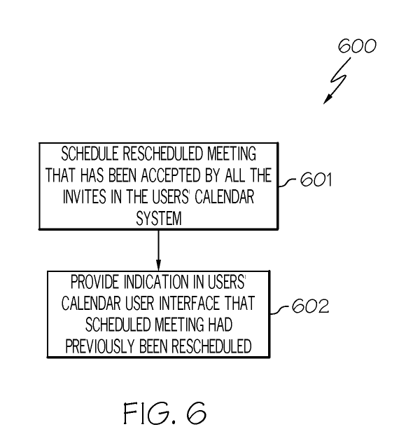

The principles of the present invention provide an enhancement to calendaring systems that provides indications that a meeting has been previously rescheduled as discussed below in connection with FIGS. 4A-4B, 5 and 6. FIGS. 4A-4B are a flowchart of a method for informing users (both the meeting initiator and meeting recipients) that a meeting has been previously rescheduled. FIG. 5 illustrates a calendar user interface that includes indications regarding the likelihood that a rescheduled meeting will be rescheduled a further time. FIG. 6 is a flowchart of a method for providing an indication in the calendar user interface of the attendees that indicates that the scheduled meeting had previously been rescheduled.

As stated above, FIGS. 4A-4B are a flowchart of a method 400 for informing users (both the meeting initiator and meeting recipients) that a meeting has been previously rescheduled in accordance with an embodiment of the present invention.

Referring to FIG. 4A, in conjunction with FIGS. 1-3, in step 401, calendar management agent 105 determines if a meeting has been rescheduled for the first time. If not, then calendar management agent 105 continues to determine if a meeting has been rescheduled in step 401.

If, however, a meeting has been rescheduled for the first time, then, in step 402, calendar management agent 105 sets a counter to the value of 1, where the counter value of 1 is associated with the meeting that has been rescheduled. The counter value of 1 indicates that the meeting has been rescheduled one time. The counter is used to store the number of times that the meeting has been rescheduled. In one embodiment, the counter is implemented in software. The counter may also be implemented in hardware or a combination of software and hardware.

In step 403, a determination is made by calendar management agent 105 as to whether any of the users, including the meeting recipients and the meeting initiator, propose to reschedule the meeting (the meeting that has been previously rescheduled) a further time.

If no user has proposed to reschedule the meeting (the meeting that has already been previously rescheduled) a subsequent time, then, in step 404, a determination is made by calendar management agent 105 as to whether the meeting has been accepted by all the invitees. That is, in step 404, a determination is made by calendar management agent 105 as to whether all of the users (e.g., users of client calendar agents 104 of clients 101) that received the meeting invitation (e.g., invitation to attend the meeting at its rescheduled date and/or time) indicated to attend the rescheduled meeting.

If all of the users indicated to attend the rescheduled meeting, then, in step 405, calendar management agent 105 stores the information regarding the number of times the meeting was rescheduled (e.g., if the meeting was finally accepted by all the invitees after the meeting was rescheduled three times, then calendar management agent 105 would store the fact that it was rescheduled three times). In one embodiment, the information is stored in the memory (e.g., memory 206) or disk unit (e.g., disk unit 208) of server 102. In step 406, calendar management agent 105 reinitializes the counter to zero, which is associated with the rescheduled meeting that has ultimately been accepted by all the invitees. Since the meeting has finally been scheduled into the calendar systems of the meeting initiator and meeting recipients, the counter is reinitialized to zero.

If, however, not all of the users have indicated to attend the rescheduled meeting, then calendar management agent 105 continues to determine if any of the users, including the meeting recipients and the meeting initiator, propose to reschedule the meeting (the meeting that has been previously rescheduled) a further time in step 403.

If a user does propose to reschedule the meeting (the meeting that has already been previously rescheduled) a subsequent time, then, in step 407, calendar management agent 105 generates an indication to the user (both the meeting initiator and meeting recipients) that the meeting has been previously rescheduled. For example, if a meeting recipient or meeting moderator proposes a new date and/or time for the meeting that has already been previously rescheduled, then an indication, such as a warning, may be displayed when a new date and/or time is proposed indicating that the meeting has already been rescheduled at least once. In this manner, the user will be informed that the meeting has already been rescheduled. The user may use this information in deciding whether to proceed with rescheduling the meeting. If the meeting has already been rescheduled, the user may decide to give this meeting priority over the other conflicting meetings/appointments.

In step 408, a determination is made by calendar management agent 105 as to whether the user decides to proceed with rescheduling the meeting that has been previously rescheduled. If the user decides to not proceed with rescheduling the meeting, then, in step 409, calendar management agent 105 does not reschedule the meeting. Calendar management agent 105 then determines whether the meeting has been accepted by all the invitees in step 404.

If, however, the user does decide to proceed with rescheduling the meeting that has been previously rescheduled, then, in step 410, calendar management agent 105 increments the counter associated with this meeting a subsequent time. For example, if the meeting has been previously scheduled one time and it is rescheduled a subsequent time, then the counter is incremented to the value of 2.

Referring to FIG. 4B, in conjunction with FIGS. 1-3, in step 411, calendar management agent 105 generates the meeting invitation for the rescheduled meeting for its new date and/or time.

In step 412, calendar management agent 105 provides an indication in the meeting invitation regarding the meeting having been rescheduled multiple times. In this manner, the meeting recipients (i.e., the invitees) would have knowledge that the meeting has been rescheduled multiple times. Based on this knowledge, the meeting recipients may make more of a concerted effort to attempt to accept and attend this meeting. In one embodiment, the indication may include but not limited to: color changes, a percentage indication, a count indicating the number of times the meeting has been rescheduled, highlighting, font changes and so forth. In one embodiment, a specific indicator may be used to signify the particular number of times that the meeting has been rescheduled. For example, the color green may be used to indicate that the meeting has been rescheduled twice; whereas, the color blue may be used to indicate that the meeting has been rescheduled three times.

In step 413, calendar management agent 105 provides an indication in the calendar user interface of the meeting invitees regarding the likelihood that the rescheduled meeting will be rescheduled a further time. Such information may be used by the recipients of the meeting invitation in deciding whether to propose an alternative date and/or time in case of a scheduling conflict. For example, if the meeting is not likely to be rescheduled again, then the recipient may be less likely to propose an alterative date and/or time in the case of a scheduling conflict. Examples of the factors used in determining whether a meeting is likely to be rescheduled a further time include, but not limited to, number of times the meeting has been rescheduled which can be determined based on the value of the counter (discussed above) associated with the meeting, current calendar schedule of the invitees and of the meeting initiator, the combination of participants (e.g., if a user's manager is invited to a meeting, then the user is likely to attend the meeting, and if the manger is likely to attend this particular meeting, then it can be assumed that the user will also attend this particular meeting), past cancellation of related meetings where such information may be obtained from calendar management agent 105 storing the number of times these related meetings have been rescheduled as discussed above in connection with step 405, etc.

Examples of an indication being included in the calendar user interface of the meeting invitees include but not limited to: color changes, a percentage indication, a count indicating the number of times the meeting has been rescheduled, highlighting, font changes and so forth. An example of a calendar user interface that includes indications as to whether meetings, that have been previously rescheduled, will be accepted by all the invitees is provided in FIG. 5.

As stated above, FIG. 5 illustrates a calendar user interface 500 that includes a series of proposed meetings 501A-501G, that have been previously rescheduled, along with an indication associated with each of these proposed meetings 501A-501G that indicates the likelihood that the meeting will be rescheduled a subsequent time in accordance with an embodiment of the present invention. Proposed meetings 501A-501G may collectively or individually be referred to as meetings 501 or meeting 501, respectively. Calendar user interface 500 may include any number of proposed meetings 501 that had previously been rescheduled. FIG. 5 is used for illustration purposes and is not intended to limit the scope of the present invention to the depicted elements shown in FIG. 5.

Referring to FIG. 5, meetings 501B, 501C and 501E are associated with an indication that indicates that the meetings will likely be accepted by all the invitees (i.e., will likely not be rescheduled). Meetings 501D and 501F are associated with an indication that indicates that there is a decent possibility (e.g., 50% probability) that the meetings will be rescheduled. Meetings 501A and 501G are associated with an indication that indicates that most likely these meetings will be rescheduled.

Returning to FIG. 4B, in conjunction with FIGS. 1-3, upon providing an indication in the calendar user interface of the meeting invitees regarding the likelihood that the rescheduled meeting will be rescheduled a further time, a determination is made by calendar management agent 105 as to whether any of the users, including the meeting recipients and the meeting initiator, propose to reschedule the meeting (the meeting that has been previously rescheduled) a further time in step 403.

In some implementations, method 400 may include other and/or additional steps that, for clarity, are not depicted. Further, in some implementations, method 400 may be executed in a different order presented and that the order presented in the discussion of FIGS. 4A-4B is illustrative. Additionally, in some implementations, certain steps in method 400 may be executed in a substantially simultaneous manner or may be omitted.

Once a meeting that has previously been rescheduled has been accepted by all of the invitees, the meeting will be scheduled in the users' calendar system where the users' calendar user interface may include an indication that shows that the scheduled meeting had previously been rescheduled as discussed below in connection with FIG. 6.

FIG. 6 is a flowchart of a method 600 for providing an indication in the calendar user interface of the attendees that indicates that the scheduled meeting had previously been rescheduled in accordance with an embodiment of the present invention.

Referring to FIG. 6, in conjunction with FIGS. 1-3, in step 601, calendar management agent 105 schedules the meeting (meeting that has previously been rescheduled) that has been accepted by all of the invitees in the users' (both the meeting initiator and meeting recipients) calendar system.

In step 602, calendar management agent 105 provides an indication in the users' calendar user interface indicating that the scheduled meeting had previously been rescheduled. In one embodiment, the indication may include but is not limited to: color changes, a percentage indication, a count indicating the number of times the meeting has been rescheduled, highlighting, font changes and so forth. In this manner, the user is provided with knowledge that the scheduled meeting had previously been rescheduled.

In one embodiment, the user may have the ability in the user's calendar system to determine how many days have elapsed since the rescheduled meeting had originally been scheduled to take place. For example, the calendar system may provide an option for the user to select an option displayed in the user's calendar user interface to provide such information for a selected meeting.

In some implementations, method 600 may include other and/or additional steps that, for clarity, are not depicted. Further, in some implementations, method 600 may be executed in a different order presented and that the order presented in the discussion of FIG. 6 is illustrative. Additionally, in some implementations, certain steps in method 600 may be executed in a substantially simultaneous manner or may be omitted.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A method for informing users regarding the rescheduling of a meeting, the method comprising:
determining a meeting has been rescheduled; and
generating, by a processor, an indication to a user regarding said meeting having been previously rescheduled in response to said user proposing to subsequently reschedule said rescheduled meeting.

2. The method as recited in claim 1 further comprising:
setting a counter to a first value in response to said meeting having been rescheduled; and
incrementing said counter to a second value in response to said user deciding to proceed with rescheduling said rescheduled meeting a subsequent time, wherein said second value is one greater than said first value.

3. The method as recited in claim 2 further comprising:
generating a meeting invitation for said subsequently rescheduled meeting; and
providing an indication in said meeting invitation regarding said subsequently rescheduled meeting having been rescheduled a number of times corresponding to said second value of said counter.

4. The method as recited in claim 3, wherein said indication comprises one or more of the following: a color, a percentage indication, a count, highlighting and font changes.

5. The method as recited in claim 3 further comprising:
providing an indication in a calendar user interface regarding a likelihood that said subsequently rescheduled meeting will be rescheduled a further time.

6. The method as recited in claim 1 further comprising:
scheduling said subsequently rescheduled meeting in a calendar system; and
providing an indication in a calendar user interface that said subsequently rescheduled meeting had previously been rescheduled.

7. The method as recited in claim 1, wherein said user corresponds to one of a meeting initiator and a meeting recipient.

8. A computer program product embodied in a computer readable storage medium for informing users regarding the rescheduling of a meeting, the computer program product comprising the programming instructions for:
determining a meeting has been rescheduled; and
generating an indication to a user regarding said meeting having been previously rescheduled in response to said user proposing to subsequently reschedule said rescheduled meeting.

9. The computer program product as recited in claim 8 further comprising the programming instructions for:
setting a counter to a first value in response to said meeting having been rescheduled; and
incrementing said counter to a second value in response to said user deciding to proceed with rescheduling said rescheduled meeting a subsequent time, wherein said second value is one greater than said first value.

10. The computer program product as recited in claim 9 further comprising the programming instructions for:
generating a meeting invitation for said subsequently rescheduled meeting; and
providing an indication in said meeting invitation regarding said subsequently rescheduled meeting having been rescheduled a number of times corresponding to said second value of said counter.

11. The computer program product as recited in claim 10, wherein said indication comprises one or more of the following: a color, a percentage indication, a count, highlighting and font changes.

12. The computer program product as recited in claim 10 further comprising the programming instructions for:
providing an indication in a calendar user interface regarding a likelihood that said subsequently rescheduled meeting will be rescheduled a further time.

13. The computer program product as recited in claim 8 further comprising the programming instructions for:
scheduling said subsequently rescheduled meeting in a calendar system; and
providing an indication in a calendar user interface that said subsequently rescheduled meeting had previously been rescheduled.

14. The computer program product as recited in claim 8, wherein said user corresponds to one of a meeting initiator and a meeting recipient.

15. A system, comprising:
a memory unit for storing a computer program for informing users regarding the rescheduling of a meeting; and
a processor coupled to said memory unit, wherein said processor, responsive to said computer program, comprises:
circuitry for determining a meeting has been rescheduled; and
circuitry for generating an indication to a user regarding said meeting having been previously rescheduled in response to said user proposing to subsequently reschedule said rescheduled meeting.

16. The system as recited in claim 15, wherein said processor further comprises:
circuitry for setting a counter to a first value in response to said meeting having been rescheduled; and
circuitry for incrementing said counter to a second value in response to said user deciding to proceed with rescheduling said rescheduled meeting a subsequent time, wherein said second value is one greater than said first value.

17. The system as recited in claim 16, wherein said processor further comprises:
circuitry for generating a meeting invitation for said subsequently rescheduled meeting;
and circuitry for providing an indication in said meeting invitation regarding said subsequently rescheduled meeting having been rescheduled a number of times corresponding to said second value of said counter.

18. The system as recited in claim 17, wherein said indication comprises one or more of the following: a color, a percentage indication, a count, highlighting and font changes.

19. The system as recited in claim 17, wherein said processor further comprises:
circuitry for providing an indication in a calendar user interface regarding a likelihood that said subsequently rescheduled meeting will be rescheduled a further time.

20. The system as recited in claim 15, wherein said processor further comprises:
circuitry for scheduling said subsequently rescheduled meeting in a calendar system; and
circuitry for providing an indication in a calendar user interface that said subsequently rescheduled meeting had previously been rescheduled.
